(19) United States
(12) Patent Application Publication
(10) Pub. No.: US 2026/0149522 A1
(43) Pub. Date: May 28, 2026

(54) Optical Architectural Solution for Coherent Burst Mode Transmitter

(71) Applicant: Ciena Corporation, Hanover, MD (US)

(72) Inventors: James Harley, Richmond (CA); Douglas McGhan, Ottawa (CA); Michael Vitic, Chelsea (CA); Paul Chedore, Ottawa (CA)

(73) Assignee: Ciena Corporation, Hanover, MD (US)

(21) Appl. No.: 18/989,184

(22) Filed: Dec. 20, 2024

Related U.S. Application Data
(60) Provisional application No. 63/725,226, filed on Nov. 26, 2024.

(51) Int. Cl. H04J 3/16; H04B 10/50; H04B 10/61

(52) U.S. Cl. CPC H04J 3/1652; H04B 10/503; H04B 10/61

(57) ABSTRACT

A method of operating a coherent transmitter in a time division multiple access (TDMA) system includes operating in an OFF state while the coherent transmitter is not assigned to transmit data in the TDMA system, wherein operating in the OFF state comprises generating a laser output having a dummy frequency different from an active frequency used to transmit data in the TDMA system; and operating in an ON state while the coherent transmitter is assigned to transmit data in the TDMA system, wherein operating in the ON state comprises generating an active laser output having the active frequency and modulating the active laser output using a modulator. Advantageously, the coherent transmitter can be used at an optical network unit (ONU) in a coherent passive optical network (CPON).

### CROSS-REFERENCE TO RELATED APPLICATION(S)

The present disclosure claims priority to U.S. Provisional Patent Application No. 63/725,226, filed Nov. 26, 2024, the contents of which are incorporated by reference in their entirety.

### FIELD OF THE DISCLOSURE

The present disclosure relates generally to fiber optics. More particularly, the present disclosure relates to an Optical Architectural Solution for a Coherent Burst Mode Transmitter (Tx).

### BACKGROUND OF THE DISCLOSURE

Passive optical networks (PON) are a point-to-multipoint optical fiber network architecture, used for broadband access services such as fiber-to-the-home (FTTH), data center networks, etc. A PON includes an optical line terminal (OLT) at one end and multiple optical network units (ONUs) at multiple points, such as the subscriber end, with the ONUs connected to the OLT via passive splitters that distribute the optical signal without active electronic components. Current PON systems, including those at 50 Gbps, rely on intensity-modulation direct-detection (IMDD) transmission due to its simplicity and cost-effectiveness. However, to meet the growing demand for bandwidth-intensive services, Coherent PON (CPON) technology is emerging as the next evolution for speeds of 100 Gbps and beyond. CPON leverages coherent optical transmission to achieve higher capacities and extended reach, offering significant advantages over IMDD.

### BRIEF SUMMARY OF THE DISCLOSURE

The present disclosure relates to an Optical Architectural Solution for Coherent Burst Mode Transmitter (Tx). The optical modulator focuses on addressing ONU burst transmission challenges in CPON without requiring an expensive optical amplifier at the ONU. In the upstream direction, where multiple ONUs share a single wavelength to transmit data to the OLT, each ONU is scheduled by the OLT to transmit in bursts, such as up to 125 μs. During this scheduled burst, the designated ONU operates at a high enough power to ensure reliable signal transmission to the OLT. Meanwhile, the other N−1 ONUs sharing the same wavelength are required to remain OFF or operate at a very low output power to prevent interference within the OLT's optical spectrum. A critical aspect of this approach is the efficiency of resource sharing, as a specific ONU is inactive on average N−1 of the time, where N represents the total number of ONUs on the wavelength. This inactive time increases as N grows, which may be as high as 512 ONUs per wavelength. Managing these ON/OFF states across a large number of ONUs requires precise scheduling and synchronization by the OLT. The low-power OFF state is particularly important to minimize crosstalk and avoid contamination of the optical spectrum in the OLT, ensuring clean detection of the active ONU's signal.

By avoiding the need for optical amplifiers at the ONUs, which would significantly increase cost and power consumption, the design remains scalable and cost-effective for large-scale deployments. Implementing this solution requires advanced digital signal processing (DSP) and precise timing mechanisms in both the OLT and ONUs. Furthermore, the high variability in traffic loads across ONUs can create challenges in scheduling and maintaining fairness in bandwidth allocation, necessitating intelligent traffic management algorithms. This approach enables the scalable deployment of CPON technology for 100 Gbps and beyond while maintaining an economically viable architecture for mass-market adoption.

Again, the transmission challenges in a burst mode with a coherent transmitter include ensuring low power when off (not transmitting) on the shared upstream channel as well as maintaining frequency stability with a cooler (e.g., a thermoelectric cooler (TEC)) and modulator bias control while the laser is off. Variously, the present disclosure includes the following to address these transmission challenges:
(1) an operational method where a burst Tx has multiple operational states, such as ON, OFF, and SOFT OFF, to allow the burst Tx to address the burst transmission challenges in coherent transmission.
(2) a hardware approach incorporating an out-of-band dummy laser mounted on a thermoelectric cooler (TEC) in the ONU where the dummy laser can be used for thermal and frequency stability and modulator bias control without adding excess power on the upstream channel, i.e., the dummy laser is at a different frequency than the OLT is configured to detect.
(3) another hardware approach using a fast tuning laser solution such as carrier injection (CI) or electro-optic (EO) effect to tune the frequency of the active laser on and off the frequency of the upstream channel. Here, the active laser is always on solving frequency stability with the TEC and modulator bias control, but there is no excess power on the upstream channel as the active laser is tuned to the different frequency when OFF.
(4) an approach to use TDMA-N where N>1 allowing multiple OLTs to share the same ODU with a higher number of ONUs.

In an embodiment, a method of operating a coherent transmitter in a time division multiple access (TDMA) system includes operating in an OFF state while the coherent transmitter is not assigned to transmit data in the TDMA system, wherein operating in the OFF state comprises generating a dummy laser output having a dummy frequency different from an active frequency used to transmit data in the TDMA system; and operating in an ON state while the coherent transmitter is assigned to transmit data in the TDMA system, wherein operating in the ON state comprises generating an active laser output having the active frequency and modulating the active laser output using a modulator.

In another embodiment, a coherent transmitter configured for time division multiple access (TDMA) burst transmission includes one or more lasers comprising either i) a single laser tunable between an active frequency for the TDMA burst transmission and a dummy frequency different from the active frequency, or ii) two lasers including an active laser to output the active frequency and a dummy laser to output the dummy frequency; and a modulator configured to receive an output of the one or more lasers, wherein at least one of the one or more lasers are always on to provide laser stability.

In a further embodiment, a passive optical network (PON) includes an optical line terminal (OLT); and a plurality of optical network units (ONUs) configured to optically connect to the OLT via an optical distribution network (ODU), wherein each of the plurality of ONUs include one or more lasers; and a modulator configured to receive an output of the one or more lasers, wherein the output of the one or more lasers has a dummy frequency while an ONU is not assigned to transmit data to the OLT and has an active frequency while the ONU is assigned to transmit data to the OLT.

### BRIEF DESCRIPTION OF THE DRAWINGS

The present disclosure is detailed through various drawings, where like components or steps are indicated by identical reference numbers for clarity and consistency.

FIG. 1 illustrates an example PON which is a point-to-multipoint (PtMP) network architecture using time division multiple access (TDMA) for efficient sharing of optical resources.

FIG. 2 illustrates an optical spectrum of example PON implementations.

FIG. 3 illustrates a diagram of N ONUs optically connected to the OLT via the upstream channel for describing worst case interference.

FIG. 4 illustrates a coherent transmitter for an ONU with a single DFB laser and VOA for illustrating the issues with power, laser stability, and modulator control.

FIG. 5 illustrates a coherent transmitter for an ONU with asymmetric DFB lasers for solving the issues with the coherent transmitter of FIG. 4 related to power, laser stability, and modulator control.

FIG. 6 illustrates a coherent transmitter for an ONU with a single active laser which is tuned via circuitry configured to perform CI or EO effect tuning, such that the active laser is always on thereby solving the issues with the coherent transmitter of FIG. 4 related to power, laser stability, and modulator control.

FIG. 7 illustrates a flowchart of a process of operating a coherent transmitter in a time division multiple access (TDMA) system.

FIG. 8 illustrates a flowchart of another process of operating a coherent transmitter in a TDMA system.

FIG. 9 illustrates a network diagram of a coherent TDMA wavelength division multiplexed (WDM) (TWDM) PON network.

### DETAILED DESCRIPTION OF THE DISCLOSURE

Again, this disclosure provides an optical architectural solution for coherent burst mode transmitter (Tx).

### PON Network

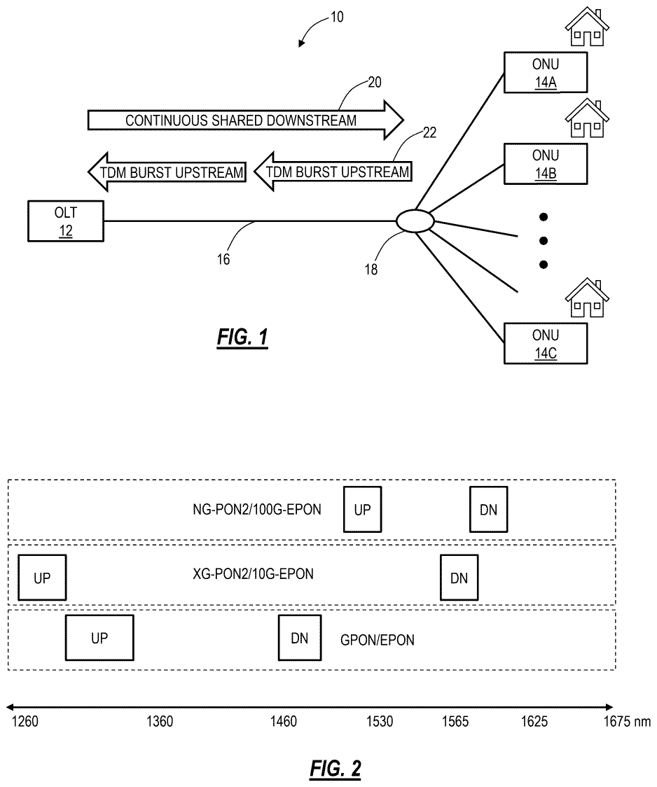

FIG. 1 illustrates an example PON 10 which is a point-to-multipoint (PtMP) network architecture using time division multiple access (TDMA) for efficient sharing of optical resources. In this architecture, a single Optical Line Terminal (OLT) 12 connects to multiple Optical Network Units (ONUs) 14A-14C via a fiber optic cable 16. The cable links to a passive optical splitter 18, which distributes the signal from the OLT to the ONUs. Split ratios typically support configurations of up to 64 ONUs (1:64 split), 128 ONUs (1:128 split), or even 512 ONUs (1:512 split) per OLT, enabling broad coverage with a single terminal. PONs generally operate over distances of up to 20 km between the OLT 12 and the furthest ONU 13, with some extended configurations allowing up to 30 km. A key characteristic is the maximum differential distance of 20 km between the closest and furthest ONUs, which must be managed to maintain signal integrity and timing accuracy.

In the downstream direction, represented by a downstream channel 20, the OLT 12 continuously transmits data to all connected ONUs 14 using a single transmitter at the OLT 12 operating at a fixed wavelength, as specified by standards such as ITU-T G.9807.1. The passive optical splitter 18 replicates the optical signal to all ONUs 14, and each ONU 14 receives and demodulates the same optical signal. To ensure proper data delivery, the OLT 12 assigns unique allocation identifiers during the discovery and registration process. These identifiers allow each ONU 14 to extract its specific data from the shared downstream signal.

In the upstream direction, represented by an upstream channel 22, the ONUs 14 transmit data back to the OLT 12 using a single fixed wavelength, separate from the downstream wavelength. To avoid collisions on the shared channel, the PON 10 uses a TDMA mechanism. The OLT 12 coordinates upstream transmissions by granting each ONU 14 a specific time slot during which it can transmit, along with instructions on the allowed transmission duration (measured in time or bytes). This scheduling ensures that transmissions from multiple ONUs 14 do not overlap, enabling successful reception and demodulation at the OLT 12.

The versatility of PON technology lends itself to a wide range of applications, such as:
(1) Fiber-to-the-Home (FTTH): PONs are extensively deployed in FTTH networks to deliver high-speed broadband services to residential users. Here, the OLT 12 can be located in a central office and each ONU 14 at a residence.
(2) Data Center Interconnects: PONs are used in data centers for interconnecting servers, storage devices, and switches. Here, the OLT 12 can be located at a switch or router and the ONUs 14 are each at a server, storage device, etc.
(3) Campus and Enterprise Networks: PONs can serve as the backbone for campus and enterprise networks, providing unified, scalable, and cost-effective connectivity for office buildings, university campuses, and large institutions.
(4) Smart Cities and IoT: PONs support smart city initiatives by connecting various IoT devices, such as sensors, cameras, and smart grids, to a centralized network.
(5) 5G Backhaul and Fronthaul: With the increasing rollout of 5G networks, PONs are being used to connect 5G base stations to core networks. Here, the ONUs 14 can be at the base stations and the OLT 12 at a switch or router connected to the core network.

FIG. 2 illustrates an optical spectrum of example PON implementations. The PON 10 uses separate wavelengths for the downstream channel 20 and the upstream channel 22 transmissions, adhering to specific optical spectrum allocations defined by standards like ITU-T G.9807.1. The choice of wavelengths and the separation between them ensure interference-free operation, allowing PONs to coexist with other optical services in the same fiber infrastructure.

### Upstream Channel in CPON

The present disclosure includes a design for the transmitter at the ONU 14. As noted above, conventional PON implementations at up to 25 Gbps use IMDD transmitters which are highly suited due to their simplicity, cost-effectiveness, and compatibility with burst-mode operations. In this regime IMDD<=25 Gbps uses straightforward on-off keying (OOK) to modulate the optical signal's intensity, requiring no complex phase or polarization controls. This makes it easy to synchronize with the OLT's 12 time-slot allocations and ensures quick transitions between on and off states, critical for TDMA systems. IMDD's reliance on mature, cost-effective components, such as DFB lasers, minimizes costs while reducing power consumption, which is essential for large-scale ONU 14 deployment. Note with bitrates beyond 25 Gbps the performance for IMDD becomes challenging due to chromatic dispersion, polarization mode dispersion and the 25 Gbps+ needs to deploy expensive component like DSP ASIC and additional optical amplification to meet the link budget. Since IMDD detection can not operate on the optical Electrical Field, these linear impairments in the optical Electrical field from chromatic dispersion and polarization mode dispersion, are only compensated in a very limited way. Coherent detection on the other hand, which directly detects the optical Electrical field, these linear impairments can be perfectly compensated with powerful linear DSP equalizers. The promise of coherent PON is extended link budget up to 80 Km due to improved Receiver sensitivity relative to IMDD, and total freedom of choice of optical frequency to co-exist with other older IMDD PON services on the optical plant, with excellent compensation of Chromatic Dispersion and Polarization Mode dispersion. For CPON to be viable the challenge is that 100G+ CPON needs to be only a small cost adder relative to the cost baseline of the costly 50G IMDD PON.

In CPON, key challenges arise on the upstream channel 22, where up to 512 ONUs 14 share a single wavelength to transmit data to the OLT 12, via TDMA where each ONU 14 is assigned a specific burst slot for transmission. These include the need for rapid startup and synchronization to establish phase and wavelength stability, which are critical for coherent transmission but challenging in short, time-slotted bursts.

One aspect of the ONU 14 transmitter is a cost-effective optical design that simultaneously addresses key challenges in coherent transmission for the PON 10. This design eliminates slow thermal laser frequency transients, ensures compliance with the low output power specifications for both the OFF state and a newly defined SOFT OFF state, and provides active control over the bias points of the Quadrature Phase Mach-Zehnder modulator. Another aspect is the introduction of a SOFT OFF state for the ONU 14. This state is enabled for a single ONU just before transitioning to the fully active ON state, while the remaining N−2 ONUs 14 remain in the OFF state. The SOFT OFF state allows the ONU 14 to stabilize its optical frequency and mitigate adiabatic chirp within about 0.1 μs, ensuring that the signal remains within the OLT's 12 optical spectrum. This transitional state improves frequency stability and reduces spectral interference, paving the way for precise and reliable burst-mode operation.

This third mode of SOFT OFF, separate from ON and OFF modes, is merely called SOFT OFF here for illustrative purposes. Those skilled in the art will recognize other names for the mode are possible and contemplated herein, namely any mode that is used in a coherent burst transmitter to prepare for transmission.

### ONU OFF Power Limit and Soft OFF Power Limit Definition

Assume there are N ONUs 14, N being an integer>1, such as 32, 64, 128, 512, etc., with the N ONUs 14 sharing the upstream channel 22 using TDMA, then one ONU is ON, another ONU 14 is in a SOFT OFF, and the other N−2 ONUs 14 are OFF. Note, as described herein, the concept of the ONU 14 being on is described with reference to the ONU 14 transmitter on the upstream channel 22. Of course, only one transmitter can be ON at a time on the upstream channel 22. It is significantly more challenging to perform this functionality with coherent transmitters than with IMDD.

The ONU OFF Max Power is the maximum power in the OLT channel spectrum on the upstream channel 22 when the ONU 14 is OFF. The ONU Soft OFF Max Power is the maximum power in the OLT channel spectrum on the upstream channel 22 when the ONU 14 in soft OFF mode. The SOFT OFF mode is used by the ONU 14 next up to transmit on the upstream channel 22 to enable this ONU 14 to stabilize optical frequency within 0.5 μs in the OLT channel spectrum with a less restrictive output power limit. That is, the SOFT OFF mode allows an upcoming coherent transmitter to get ready in terms of frequency stability (either addressing adiabatic chirp or performing fast tuning to the frequency on the upstream channel 22), without adding excess power to the upstream channel 22.

With turning the coherent transmitter on and off, on for the burst transmission and off for the remaining time while other ONUs 14 transmit, there is adiabatic chirp. Adiabatic chirp refers to a gradual, predictable change in the frequency of a laser's output due to variations in the laser's operating conditions, particularly its drive current. It occurs during modulation of the laser's optical output, where changes in the amplitude of the light are accompanied by corresponding changes in the refractive index of the laser cavity. This relationship causes a shift in the laser's emission frequency (wavelength) that follows the modulation pattern. For a coherent transmitter, adiabatic chirp arises primarily when intensity modulation is applied to the laser, such as when turning it ON or OFF in burst-mode operation. The thermal and carrier-density effects within the laser's active region influence the refractive index, leading to a predictable frequency drift that aligns with the intensity change.

The concept of the Soft OFF enables management of the adiabatic chirp, in less than 0.5 μs. Note adiabatic chirp can be less than 0.5 μs but thermal stability of the TEC will be much longer than 0.5 μs. The TEC needs to be stable for ON, Soft OFF, and OFF states.

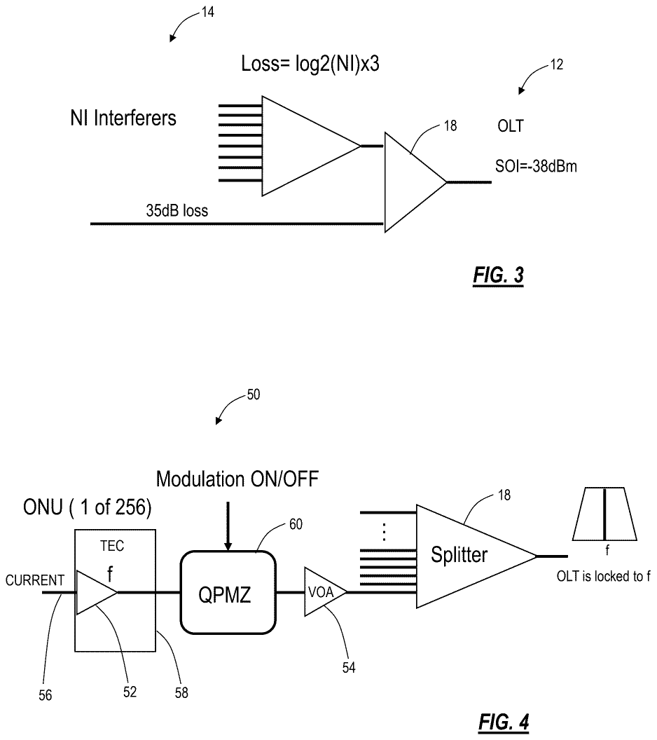

FIG. 3 illustrates a diagram of N ONUs 14 optically connected to the OLT 12 via the upstream channel 22 for describing worst case interference. That is, all ONUs 14 are optical connected to the OLT 12 via the ODU, e.g., including the splitter 18. Assume the ONU 14 transmitter has a maximum output power of 0 dBm, the OLT 12 receiver has a minimum receiver sensitivity of −38 dBm, and a target signal to interference ratio (SIR) of 16 dBm.

The following table illustrates example values in the PON 10 for different numbers of interferers, NI.

| | | | Path | NI channels | | | |
|---|---|---|---|---|---|---|---|
| | | 1 Interferer | Difference | Power at OLT | NI channels | 1 Soft Off | |
| | | Power at OLT, | Between | Power, | Power at OLT, | at ONU | |
| | Spitter | with ONU Tx | SOI and | with ONU Tx | with ONU Tx | Tx −39 dBm, | SIR at |
| NI | Loss | Power = 0 dBm | Interference | Power = 0 dBm | at −54 dBm | Power at OLT | OLT |
| 32 | 15 dB | −18 dBm | 20 dB | −3 dBm | −57 dBm | −57 dBm | 16 dB |
| 64 | 18 dB | −21 dBm | 17 dB | −3 dBm | −57 dBm | −60 dBm | 17.2 dB |
| 128 | 21 dB | −24 dBm | 14 dB | −3 dBm | −57 dBm | −63 dBm | 18.0 dB |
| 256 | 24 dB | −27 dBm | 11 dB | −3 dBm | −57 dBm | −66 dBm | 18.5 dB |
| 512 | 27 dB | −30 dBm | 8 dB | −3 dBm | −57 dBm | −69 dBm | 18.7 dB |

In an embodiment, the ONU OFF Max Power is set to −54 dBm and the ONU Soft OFF Max Power is −39 dBm.

CPON with Single DFB and VOA

FIG. 4 illustrates a coherent transmitter 50 for an ONU 14 with a single DFB laser 52 and VOA 54 for illustrating the issues with power, laser stability, and modulator control. A current 56 is provided to the DFB laser 52 to turn the laser on and off and the DFB laser 52 operates at a frequency f. The DFB laser 52 is a semiconductor laser with a built-in diffraction grating to provide wavelength-selective feedback, enabling it to emit light at a stable, single frequency with narrow linewidth. A thermoelectric cooler (TEC) 58 is used with the DFB laser 52 to stabilize the laser's temperature, ensuring consistent operation. By maintaining a precise temperature, the TEC 58 prevents thermal variations that could shift the laser's emission frequency, allowing the laser to remain “locked” to the frequency f.

The DFB laser 52 is connected to a modulator 60, e.g., a quad-parallel Mach-Zehnder (QPMZ) modulator. The QPMZ modulator 60 combines four Mach-Zehnder Modulators (MZMs) to independently control the in-phase (I) and quadrature (Q) components of two polarization states (X and Y) of light. This setup enables advanced modulation formats, such as 16-quadrature amplitude modulation (QAM) or dual-polarization quadrature phase shift keying (DP-QPSK), for high-capacity coherent transmission. The QPMZ modulates the light from the DFB laser 52 by splitting the laser's continuous-wave output into its components, modulating the phase and amplitude through the MZMs, and then recombining the signals to produce a complex optical waveform suitable for transmission.

The QPMZ modulator is turned ON or OFF by controlling the bias voltages applied to its individual Mach-Zehnder arms. In the OFF state, the bias is adjusted such that destructive interference suppresses the optical output. Conversely, in the ON state, the bias is set to the quadrature point, enabling modulation of the in-phase (I) and quadrature (Q) components to generate the desired optical signal. This rapid control allows precise burst-mode operation in systems like PONs.

The VOA 54 is connected to the output of the modulator 60. The VOA 54 is used to dynamically adjust the optical power of the modulated signal before it is transmitted. VOAs can typically attenuate power by up to 20-30 dB, allowing fine-tuning to meet power budget requirements, avoid overloading receivers, or maintain compliance with optical network specifications. By reducing the power output as needed, the VOA 54 ensures optimal signal performance while minimizing interference in the upstream channel 22 to the OLT 12 via the splitter 18. The OLT 12 has a receiver located to the frequency f, configured to receive a single from each ONU 14 during its corresponding burst.

With the DFB laser 52, the modulator 60, and the VOA 54, there can be four operational states and there is no solution that supports the required power on the upstream channel 22, laser stability, and modulator control in the transmitter 50, with the shown hardware.

In a first state, the transmitter 50 is on, transmitting in its assigned burst—the laser 52 and the modulator 60 are ON, the VOA 54 is set to a minimum, the output power is 0 dBm, and the laser frequency stability and modulator control are good.

In the remaining states, the transmitter 50 is off, i.e., another ONU 14 is transmitting. In a second state, the laser 52 is ON, the modulator 60 is OFF, and the VOA 54 is set to a minimum. While, the laser frequency stability and modulator control are good in the second state, the power fails as it is above both the ONU OFF Max Power of −54 dBm and the ONU Soft OFF Max Power of −39 dBm. QPMZ bias error light and control dithers generate light up to ˜25 dBm peak, failing the <−54 dBm and <−39 dBm thresholds.

In a third state, the laser 52 is ON, the modulator 60 is OFF, and the VOA 54 is set to a maximum, e.g., 20 dB maximum attenuation. While, the laser frequency stability and modulator control are good in the third state, the power is good for the <−39 dBm threshold but fails for the <−54 dBm threshold. Thus, while keeping the laser 52 on maintains laser frequency stability and modulator control, in the second and third state, this approach causes the transmitter 50 to provide too much interfering power on the upstream channel 22.

In a fourth state, the laser 52 and the modulator 60 are OFF, and the VOA 54 is set to a maximum, e.g., 20 dB maximum attenuation. This fourth state is good for power, but the laser frequency stability and modulator control fail. Laser frequency accuracy fails due to slow thermal transient with turning the laser 52 on and off with the TEC 58 and the QPMZ bias point control is problematic.

These states are summarized in the following table:

| | | | | | Laser | |
|---|---|---|---|---|---|---|
| | | | VOA | | frequency | QPMZ |
| State | Laser | Mod | (iTEMP) | Power | stability | control |
| 1 | ON | ON | Min | 0 dBm | Good | Good |
| 2 | ON | OFF | Min | Fail −54 dBm | Good | Good |
| | | | | and −39 dBm | | |
| 3 | ON | OFF | Max | Good for −39 | Good | Good |
| | | | (20 dB | dBm and Fail | | |
| | | | attenuation | for −54 dBm | | |
| | | | max) | | | |
| 4 | OFF | OFF | Max | Good for −39 | Fail | Fail |
| | | | | dBm and Good | | |
| | | | | for −54 dBm | | |

### DFB Laser Frequency Dynamics

The frequency dynamics of the DFB laser 52 are influenced by both thermal stability and adiabatic effects, making frequency control a critical challenge in optical systems. The thermal stability of the laser 52, managed by the TEC 58, directly affects the laser's frequency, with a sensitivity of approximately 12.5 GHz per degree Celsius. However, the TEC 58 operates with a time constant in the kilohertz range, making it too slow to respond to rapid transitions in burst-mode operation. Ensuring the TEC 58 remains stable during transitions, such as from an OFF to an ON state, is a key technical challenge to prevent frequency drifts that could disrupt coherent transmission.

In contrast, adiabatic effects, caused by changes in the refractive index of the laser cavity due to variations in carrier density, lead to frequency shifts that occur on a much faster timescale, approximately 100 nanoseconds. This rapid frequency change is significant during the laser's ON and OFF transitions but can be effectively managed by introducing the “SOFT OFF” mode. In this mode, the laser 52 operates at a low output power, allowing its frequency to stabilize before fully turning ON, thereby mitigating the impact of adiabatic chirp.

Another critical factor is the laser's turn-on delay jitter, which is dependent on the driving circuit. Variations in this delay can impact the timing precision required for burst-mode operation. By incorporating the turn-on delay management into the SOFT OFF mode, the system can ensure smoother transitions and reduce jitter-related errors, further stabilizing the laser frequency for reliable operation in dynamic optical networks.

### Light Sources and Attenuation Options

The behavior of light sources and the effectiveness of attenuation mechanisms in optical systems vary depending on the operational state of the laser 52 and the modulator 60. These factors are critical in ensuring stable, reliable performance across different scenarios. First, unguided laser light coupled into a fiber via a silicon substrate can exhibit extremely low power levels, often around −60 dBm or lower. This light bypasses attenuation mechanisms on the guided waveguide and can introduce noise or crosstalk in sensitive optical systems if not managed properly.

When the laser 52 is ON but the modulator 60 is OFF, error light guided in the waveguide arises due to imperfections in the gain and control balance within the QPMZ modulator. Additionally, dithering used to stabilize the QPMZ bias points can introduce residual light. This error light typically measures around −30 dBm but can peak as high as −25 dBm due to the dithering effect. These imbalances and residuals can interfere with signal quality, requiring careful calibration and compensation.

With modulator 60 is turned ON, the digital-to-analog converter (DAC) introduces limitations in the signal-to-noise ratio (SNR), even in spectral regions where no signal is present. The achievable SNR is approximately 25 dB, which can constrain the use of advanced techniques such as single sideband (SSB) or dual sideband suppressed carrier (DSC) methods in single-wavelength schemes. These limitations impact the efficiency and performance of high-capacity optical networks, necessitating optimization of DAC parameters and modulation schemes.

Finally, the VOA 54 provides cost-effective attenuation solutions but are generally limited to about 20 dB of attenuation. This limitation may not be sufficient in scenarios requiring higher levels of power suppression, such as managing residual light from unguided laser coupling or QPMZ error light. Advanced or higher-grade VOAs may be required to meet stricter attenuation needs in high-performance applications.

### VOA Characteristics

The VOA 54 is a significantly more cost-effective solution than a semiconductor optical amplifier (SOA) when used in conjunction with a silicon photonics (SiP) QPMZ. VOAs can operate in an open-loop configuration at maximum attenuation, simplifying their implementation and reducing system complexity. They typically provide a bandwidth of around 40 MHz, making them suitable for applications requiring moderate-speed attenuation adjustments. However, their attenuation efficiency can be limited at extreme temperatures, such as −40° C., due to absorption effects, with a current estimated maximum attenuation of approximately 20 dB.

A carrier injection VOA (CI-VOA) is necessary to achieve the SOFT OFF power target of −39 dBm while allowing the laser frequency to stabilize. This is a critical function for ensuring smooth transitions and minimal interference in burst-mode operation, particularly in systems requiring precise frequency control during the laser stabilization phase.

For applications with more stringent power requirements, a dual-DFB laser architecture can be employed to relax the constraints on achieving ultra-low power levels, such as −51 dBm. This dual-laser setup enables better control of the optical power output and frequency stabilization, enhancing performance in systems where precise power and frequency management are essential.

### QPMZ Bias Control

In the QPMZ modulator 60, precise bias control is critical to ensure optimal performance and signal integrity. The inner Mach-Zehnder (MZ) modulators are actively controlled to minimize output power, ensuring the carrier signals are appropriately suppressed and maintaining efficient modulation. Meanwhile, the outer MZ modulator is actively controlled to establish a 90-degree relative phase shift between the in-phase (I) and quadrature (Q) components, a requirement for generating complex modulation formats like quadrature phase shift keying (QPSK) or QAM.

A significant challenge arises when the ONU laser 52 is OFF for the majority of the time, e.g., 255 out of 256 of the TDMA cycle. In such cases, maintaining active control of these bias points becomes non-trivial, as the absence of continuous optical power complicates real-time monitoring and adjustments. To address this, in an embodiment, the present disclosure uses an auxiliary light source (e.g., a dummy laser or pilot tone) during the OFF state to provide a reference signal for bias control. This method ensures that when the laser 52 transitions to the ON state, the QPMZ modulator 60 is already configured for accurate and stable modulation, minimizing delay and errors in burst-mode operation. In another embodiment, the present disclosure uses a limited, fast tuning to change the frequency of the active laser between the ON and OFF state, and using the SOFT OFF state to tune back to the frequency of interest on the upstream channel 22. This approach keeps the active laser always on solving frequency stability with the TEC and modulator bias control while also not adding excess power to the upstream channel 22, as the frequency is different in the OFF state (e.g., a dummy laser frequency).

### Asymmetric Dual DFB Solution

In an embodiment, this disclosure introduces a novel approach to address critical requirements for CPON by incorporating an out-of-band dummy laser mounted on the TEC in the ONU. The dummy laser plays a pivotal role in achieving three key objectives necessary for efficient CPON operation. First, it thermally stabilizes the active laser, ensuring consistent performance and reliable transmission even during burst-mode operation. Second, it provides light in the modulator, enabling accurate bias control of the optical signal, which is crucial for maintaining coherent transmission. Lastly, it maintains low in-band power during the ONU's off state, preventing interference and maintaining spectral integrity for other ONUs sharing the wavelength. Note, we use the term “dummy” because this laser is only used for keeping the TEC operational for frequency stability and maintaining bias control of the modulator, while the coherent transmitter is in the OFF state.

Additional features include a 90/10 optical splitter employed to preferentially pass active light, ensuring efficient utilization of optical power while minimizing unnecessary losses. Furthermore, the use of a low-cost carrier injection semiconductor optical amplifier (SOA) significantly reduces the overall cost of the system while maintaining the required performance for coherent transmission. The various aspects collectively address the technical challenges of burst-mode operation in CPON systems while ensuring thermal stability, precise bias control, and low power consumption.

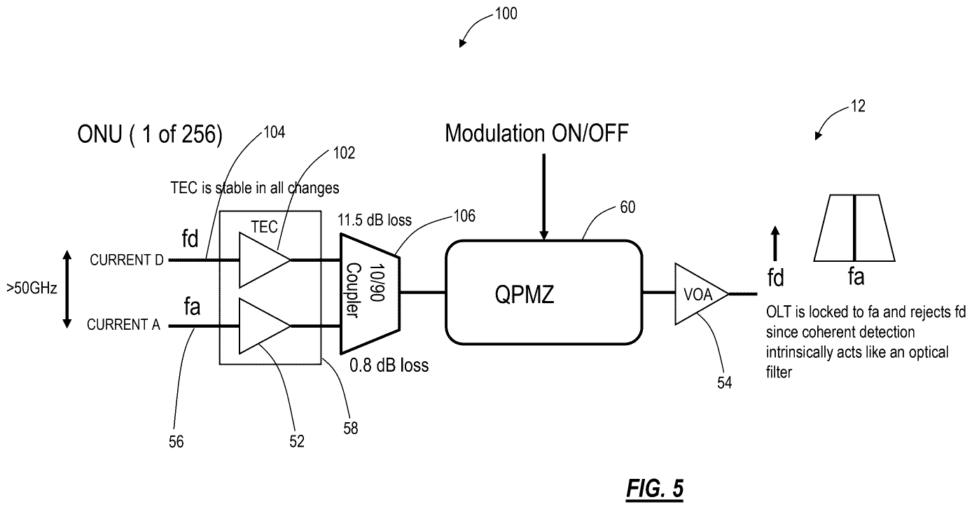

FIG. 5 illustrates a coherent transmitter 100 for an ONU 14 with asymmetric DFB lasers 52, 102 for solving the issues with the coherent transmitter 50 related to power, laser stability, and modulator control. The coherent transmitter 100 includes some of the same components as the coherent transmitter 50, namely the DFB laser 52 controlled by the current 56, the VOA 54, the TEC 58, and the QPMZ modulator 60. Additionally, the coherent transmitter 100 includes an auxiliary light source, referred to as a dummy DFB laser 102, controlled by a current 104, with the dummy DFB laser 102 and the DFB laser 52 connected to the QPMZ modulator 60 via a coupler 106, e.g., a 10/90 coupler 106.

The dummy DFB laser 102 operates at a frequency fd (d is for dummy) and the DFB laser 52 operates at a frequency fa (a is for active). The dummy DFB laser 102 can be referred as out-of-band, meaning the frequency fd is different from the frequency fa, such as by at least 50 GHz spacing. As shown at the OLT 12, logically in FIG. 5, the OLT is locked to fa and rejects fd since coherent detection intrinsically acts like an optical filter.

In a silicon photonics (SiP) implementation, the two DFB lasers 52, 102 can be mounted on the same silicon substrate or close proximity within a photonic chip, allowing them to share a common thermal environment controlled by the TEC 58. The TEC 58 actively maintains a consistent temperature across both lasers 52, 102, preventing thermal-induced frequency drift and ensuring wavelength stability. Electrical interconnects and independent drive circuits allow each laser 52, 102 to operate at its specific wavelength.

The 10/90 coupler 106 is a passive optical device used to combine input optical signals from the lasers 52, 102 into a single output to the QPMZ modulator 60 with a predetermined power ratio, typically 10% and 90%. It operates based on the principle of optical splitting through waveguide design or fused fiber techniques. The two input signals are introduced into separate waveguides of the coupler 106, where they interact in the coupling region. This region redistributes the optical power from the inputs into a single output signal.

In this configuration, the combined output signal consists of 90% of the power from one input, i.e., the DFB laser 52, and 10% of the power from the other, i.e., the DFB laser 102, preserving the relative contributions of the two sources. The 90% is for the active, DFB laser 52, whereas the 10% is for the dummy DFB laser 102. For example, the couple 106 can have an 11.5 dB loss with the dummy DFB laser 102, and only a minor 0.8 dB loss with the active laser 52.

The dummy DFB laser 102 enables achieving the three key objectives—power, laser stability, and modulator control. First, the dummy DFB laser 102 can be used to thermally stabilize the active DFB laser 52 by maintaining consistent thermal conditions within the shared environment, such as on the TEC 58. Temperature fluctuations can cause shifts in the refractive index and cavity length of a laser, leading to frequency drift and instability in the emitted light. By using the dummy DFB laser 102 alongside the active DFB laser 52, thermal variations are mitigated, ensuring consistent performance and reliable transmission.

The dummy DFB laser 102 operates during the OFF state, generating heat that balances the thermal environment within the TEC 58. This ensures the active DFB laser 52 remains at a stable operating temperature, even when it transitions between OFF and ON states during burst-mode operation. Burst-mode operation is particularly challenging because the rapid power cycling of the active laser can introduce sudden thermal transients, disrupting wavelength stability. The dummy DFB laser 102 prevents these transients by providing a baseline thermal load, enabling the TEC 58 to maintain a consistent temperature.

Second, the dummy DFB laser 102 provides light in the OFF state to the QPMZ modulator 60, enabling accurate bias control of the optical signal, which is crucial for maintaining coherent transmission. The dummy DFB laser 102 can be used to maintain bias control by providing a continuous optical signal during times when the active DFB laser 52 is OFF. This is particularly useful in systems like Quad-Parallel Mach-Zehnder Modulators (QPMZ), where maintaining precise bias points is critical for modulation accuracy and signal integrity.

When the active DFB laser 52 is OFF, there is no optical power to monitor and adjust the bias points of the QPMZ modulator 60. The dummy DFB laser 102, operating at a low-power state, provides a stable optical signal that passes through the modulator 60, enabling real-time feedback for bias stabilization. By ensuring that the modulator 60 remains in its optimal quadrature operating point, the dummy DFB laser 102 prevents drift and ensures the modulator 60 is ready for immediate use when the active laser transitions back to the ON state.

This approach is especially beneficial in burst-mode operations, such as in TDMA, where the active DFB laser 52 is typically OFF for most of the time (e.g., 255/256 of the cycle). The dummy DFB laser 102 keeps the modulator 60 calibrated and operational, avoiding delays and errors that could occur from bias drift during idle periods. Additionally, the dummy DFB laser 102 can also be used to provide light for monitoring quadrature points and compensating for environmental variations, further enhancing the stability and reliability of the optical system.

Lastly, the dummy DFB laser 102 maintains low in-band power during the ONU's off state, preventing interference and maintaining spectral integrity for other ONUs sharing the wavelength. The dummy DFB laser 102 maintains low in-band optical power during the ONU's OFF state by operating at a reduced power level and outside the primary transmission band. This approach prevents interference with other ONUs sharing the same wavelength in a TDMA PON, ensuring spectral integrity.

When the active DFB laser 52 of an ONU is OFF, the dummy DFB laser 102 provides just enough optical power for functions like thermal stabilization and bias control without contributing significant noise within the operational wavelength band. By keeping the dummy DFB laser's 52 power output low, typically below thresholds (e.g., −39 dBm), it avoids disrupting the upstream channel or overlapping with signals transmitted by other ONUs during their designated time slots.

Moreover, the dummy DFB laser's 52 design minimizes in-band emissions, and any residual light is attenuated further by mechanisms such as the VOA 54. This ensures that the dummy DFB laser's 52 presence is negligible within the OLT's receiver spectrum, allowing the system to maintain clear and interference-free communication among all ONUs sharing the wavelength. This low-power operation, combined with effective isolation, ensures the dummy laser supports system stability and calibration while preserving the spectral environment for high-quality PON operation.

The coherent transmitter 100 with the dummy DFB laser 102 operates in one of the states to ensure efficient burst-mode communication in TDMA. These states include ON, OFF, SOFT OFF, and transitions between them, each with specific configurations for the current to the DFB lasers 52, 102, the modulator 60, and the VOA 54.

In the ON state, the active laser current (current A) is set to its maximum value, the dummy laser current (current D) is OFF, the modulator 60 is active, and the VOA 54 is set to minimum attenuation to allow maximum optical power output. The QPMZ modulator 60 bias control is active to maintain precise modulation. This state lasts between 10 μs and 125 μs, during which the OLT 12 locks onto the active laser frequency (fa) for data reception.

In the OFF state, the dummy DFB laser 102 current (current D) is set to maximum, the active laser current (current A) is OFF, the modulator 60 is disabled, and the VOA 54 is set to maximum attenuation to minimize optical power output. The QPMZ modulator 60 bias control remains active to ensure calibration is maintained for the next ON state. This state accounts for 255/256 of the TDMA cycle, during which the OLT 12 ignores the dummy DFB laser 102 frequency (fd) and no light is emitted at the active laser frequency (fa).

During the OFF to SOFT OFF transition, the maximum current is switched to the active laser (fa) without significant fluctuation in the TEC 58, ensuring thermal stability. Only adiabatic frequency changes occur during the brief 0.1 μs transition. The modulator 60 remains OFF, the VOA 54 is set to maximum attenuation, and optical power at frequency fa is reduced to below-39 dBm to prevent interference.

The SOFT OFF to ON transition involves turning ON the modulator 60 and setting the VOA 54 to minimum attenuation, allowing the optical signal to reach full power. This transition is rapid, taking approximately 0.1 μs, ensuring minimal delay in data transmission. The ON to OFF transition involves disabling the modulator 60, setting the VOA 54 back to maximum attenuation, and switching the maximum current to the dummy laser (fd). The QPMZ modulator 60 bias control remains active during this 0.1 μs transition, preparing the system for the next cycle while ensuring frequency and power stability.

### Limited Fast Tuning Laser Solution

In the previous approach, the dummy laser 102 advantageously is on during the OFF mode while the active laser 52 is off, the active laser 52 is switched on during the SOFT OFF mode to address adiabatic chirp, and the dummy laser 102 is off during the ON mode while active laser is off. Advantageously, this approach solves the challenges described herein with coherent burst mode transmission, with two lasers. In another embodiment, the present disclosure contemplates just the active laser 52 with limited and fast tunability so that the active laser 52 is tuned to the frequency of interest (i.e., fa) on the upstream channel 22 during the SOFT OFF mode, transmitting a burst during the ON mode, and tuned off of the frequency of interest (i.e., fd) in the OFF mode. Similar to the dummy laser 102 approach, this solves the challenges, with a single laser. Conceptually, the active laser 52 performs the functionality of the dummy laser 102 in the OFF modes. Key to this approach is a fast tuning approach for the active laser 52 and limiting the frequency range of tuning.

One approach for tuning frequency is thermal tuning. Chip temperature or a microheater can tune a laser's frequency by altering the refractive index of the laser's material or its cavity dimensions, leveraging the thermo-optic effect or thermal expansion. These methods are inefficient because heating consumes significant power, is slow due to thermal inertia, and offers limited tuning range as excessive temperature changes can damage the device or degrade performance. Note, the TEC 58 performs similar functionality, i.e., thermal tuning, but for different purposes—the TEC 58 stabilizes the laser's operating temperature, ensuring frequency stability by preventing temperature-induced changes in the refractive index and cavity dimensions that would shift the laser's frequency. By maintaining a consistent thermal environment, the TEC 58 minimizes frequency drift caused by external temperature fluctuations. Stated differently, the TEC 58 is not trying to change the frequency, but to stabilize it.

Carrier injection (CI) and the electro-optic (EO) effect each tune a laser's frequency by directly modifying the refractive index of the laser material. In carrier injection, injecting electrons or holes changes the material's free-carrier density, altering its refractive index and thereby the laser cavity's optical path length, shifting the frequency. The EO effect leverages an applied electric field to induce a change in refractive index (Pockels or Kerr effect), enabling precise and rapid tuning of the frequency. Both methods are inherently faster than thermal tuning since they do not rely on heating or cooling the material, and they consume significantly less power, as they primarily involve electronic or electric field manipulations rather than thermal energy.

In an embodiment, the present disclosure utilizes CI or the EO effect to support fast tuning, e.g., <0.5 μs, which does not impact the TEC 58 and can be accommodated in the SOFT OFF condition as the active frequency is stabilized. As such, the active laser 52 can be used all of the time-ON, OFF, SOFT OFF, but at different frequencies in the ON and OFF mode, and transitioning between the different frequencies during the SOFT OFF mode.

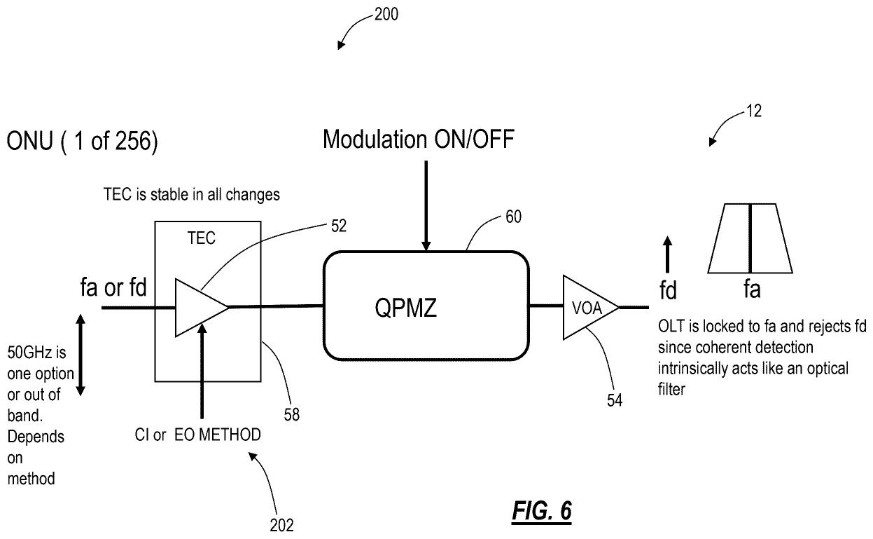

FIG. 6 illustrates a coherent transmitter 200 for an ONU 14 with a single active laser 52 which is tuned via circuitry 202 configured to perform CI or EO effect tuning, such that the active laser 52 is always on thereby solving the issues with the coherent transmitter 50 related to power, laser stability, and modulator control. Specifically, the active laser 52 is always on so the TEC 58 is able to operate stably and the modulator 60 can be biased. The excess power on the upstream channel 22 is solved by the active laser transmitting at fd in the OFF state, i.e. 50 GHz off of the frequency of interest on the upstream channel 22 or out-of-band relative thereto. The frequency of interest on the upstream channel 22 is the one the OLT 12 expects transmission on in an assigned burst-only one ONU 14 at a time transmits at this frequency. All of the other ONUs 14 are at fd (fd can be different for different ONUs), except the ONU 14 in the SOFT OFF state (the one about to transmit)—this provides no excess power on the frequency of interest on the upstream channel 22.

The different states for the coherent transmitter 200 are as follows (note, the terms states and modes are used interchangeably):
(1) ON State: the active laser 52 is tuned to Optical fa and is ON (providing power), optical fd is “OFF”, Modulation ON, VOA 54 at “Min”, QPMZ bias control on, Time duration 10 μs-125 μs. The OLT 12 locks on Optical Fa. No light at Fd at a given coherent transmitter 200 in the ON state
(2) OFF State: optical fd is on, optical fa is off, that is the active laser 52 is tuned by the circuitry 202 from fd to fa as the coherent transmitter moves from the ON state to the OFF state, Modulation OFF, VOA 54 at “Max”, and QPMZ bias control on, the OLT 12 rejects light at fd, and no light (power) at fa is generated in the OFF state.
(3) OFF→SOFT OFF: the coherent transmitter 200 has the circuitry 202 tune to fa with a fast switching method (e.g., CI or EO effect). The TEC 58 does not fluctuate. This SOFT OFF state allow 0.5 μs to stabilize to new optical frequency (fa from fd). Modulation OFF. VOA 54 at “MAX”. Power at fa<−39 dBm
(4) SOFT OFF→ON: Turn Modulation On. VOA 54 at “Min”.
(5) ON→OFF: Turn Modulation OFF. Set VOA 54 to MAX. Switch optical frequency to Fd. QPMZ bias control on.

### Process

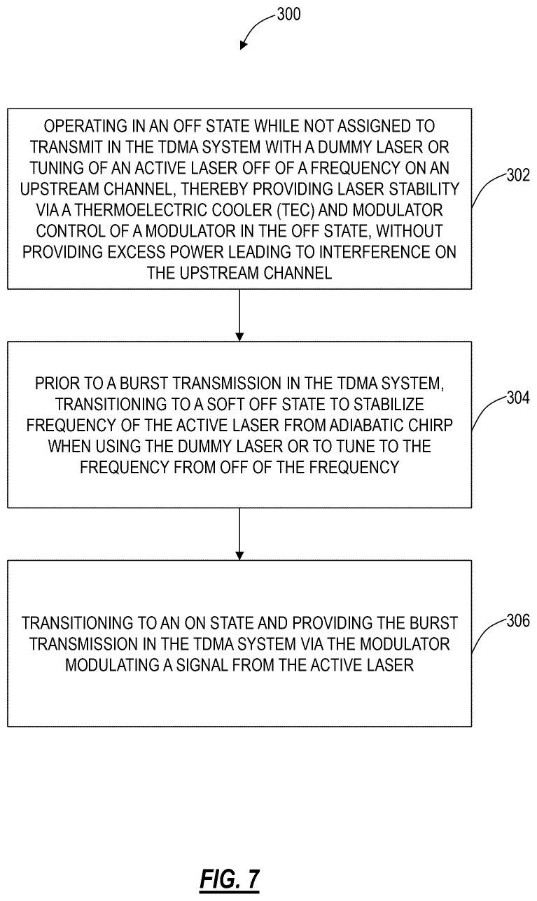

FIG. 7 illustrates a flowchart of a process 300 of operating a coherent transmitter 100 in a time division multiple access (TDMA) system. The process 300 includes operating in an OFF state while not assigned to transmit in the TDMA system with a dummy laser or tuning of an active laser off of a frequency on an upstream channel, thereby providing laser stability via a thermoelectric cooler (TEC) and modulator control of a modulator in the OFF state, without providing excess power leading to interference on the upstream channel (step 302); prior to a burst transmission in the TDMA system, transitioning to a SOFT OFF state to stabilize frequency of the active laser from adiabatic chirp when using the dummy laser or to tune to the frequency from off of the frequency (step 304); and transitioning to an ON state and providing the burst transmission in the TDMA system via the modulator modulating a signal from the active laser (step 306). The process 300 can further include operating a variable optical attenuator (VOA) connected to an output of the modulator. The operating can include setting the VOA to maximum attenuation except for when the coherent transmitter is providing the burst transmission.

The active laser and the dummy laser can both be distributed feedback (DFB) lasers in a silicon photonics (SiP) implementation. Of course, other implementations are also contemplated including Thin Film Lithium Niobate (TFLN) or other technologies. Also, the DFB Lasers and Distributed Bragg reflector (DBR) lasers can be in InP or hybrid InP/SiP. The modulator can be a quad-parallel Mach-Zehnder (QPMZ) modulator. The process 300 can further include combining outputs of both the active laser and the dummy laser for an input to the modulator, via a coupler. The coupler can have a 10/90 split with the 90 split connected to the active laser and the 10 split connected to the dummy laser. The active laser and the dummy laser can each have a different frequency. The laser tuning of the active laser can include changing to another frequency in the OFF state and to the frequency in the SOFT OFF state. The changing can be via carrier injection (CI) or electro-optic (EO) effect on the active laser.

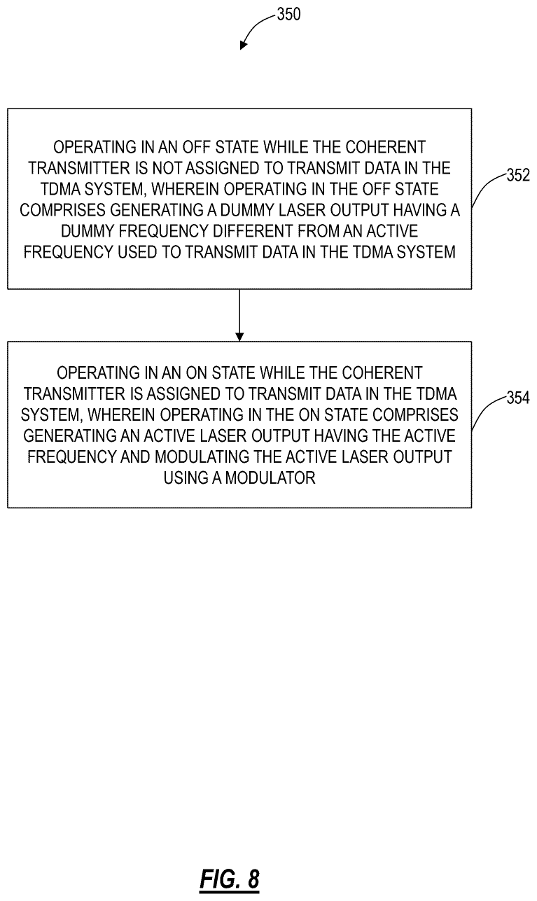

FIG. 8 illustrates a flowchart of another process 350 of operating a coherent transmitter 100 in a time division multiple access (TDMA) system. The process 350 includes operating in an OFF state while the coherent transmitter is not assigned to transmit data in the TDMA system, wherein operating in the OFF state comprises generating a dummy laser output having a dummy frequency different from an active frequency used to transmit data in the TDMA system (step 352); and operating in an ON state while the coherent transmitter is assigned to transmit data in the TDMA system, wherein operating in the ON state comprises generating an active laser output having the active frequency and modulating the active laser output using a modulator (step 354). Here, the dummy frequency can be from the dummy laser 102 in one embodiment, or from the active laser 52 in another embodiment where the active laser 52 is tuned, such as using the CI or EO approaches. Of note, having light at the dummy frequency during the OFF state addresses the problems while not adding to excess power leading to interference on the upstream channel. That is the dummy laser output is either from the dummy laser 102 or the active laser 52 tuned off of the active frequency to the dummy frequency, whereas the active laser output is always from the active laser 52 at the active frequency (either always there or tuned there using the fast tuning approaches). In some implementations, step 352 is similar to step 302 of the process 300 and/or step 354 is similar to step 306.

In an embodiment, using the dummy laser 102, operating in the OFF state includes generating the dummy laser output using a dummy laser; and operating in the ON state includes generating the active laser output using an active laser. The process 350 can further include controlling temperatures of the dummy laser and the active laser using a thermoelectric cooler (TEC). The process 350 can further include combining outputs of the active laser and the dummy laser for an input to the modulator, via a coupler. The coupler can have an A/B split with the A split connected to the active laser and the B split connected to the dummy laser, wherein the A split is greater than the B split.

In another embodiment, using the active laser 52 with the fast tuning laser solution, operating in the OFF state includes setting a laser to the dummy frequency to generate the dummy laser output; and operating in the ON state includes setting the laser to the active frequency to generate the active laser output.

The process 350 can include, prior to transitioning from the OFF state to the ON state, transitioning to a SOFT OFF state to stabilize the active laser output (e.g., similar to step 304 of the process 300). The transitioning to the SOFT OFF state can occur <5 μs prior to transitioning to the ON state. The transitioning to the SOFT OFF state can include turning off a dummy laser generating the dummy laser output and turning on an active laser producing the active laser output. The transitioning to the SOFT OFF state can include switching an output of a laser from the dummy frequency to an active frequency. The switching the output of the laser can be performed using carrier injection or an electro-optic effect.

The operating in the OFF state can include controlling the modulator using the dummy laser output. The process 350 can include operating a variable optical attenuator (VOA) connected to an output of the modulator. The operating includes the VOA can include setting the VOA to maximum attenuation except for when the coherent transmitter is in the ON state. The modulator can be a quad-parallel Mach-Zehnder (QPMZ) modulator. A coherent receiver in the TDMA system can be locked to the active frequency and the dummy frequency is rejected by the coherent receiver. The coherent transmitter can be at an optical network unit (ONU) in a passive optical network (PON) sharing an upstream channel with a plurality of additional ONUs, and the coherent receiver is at an optical line terminal (OLT) in the PON.

Coherent Transmitter with Dummy Laser or an Active Laser with a Fast-Tuning Solution

In an embodiment, a coherent transmitter 100 configured for time division multiple access (TDMA) burst transmission includes an active laser 52; a dummy laser 102; a thermoelectric cooler (TEC) 58 configured to operate with the active laser 52 and the dummy laser 102; and a modulator 60 configured to receive a combined output of the active laser 52 and the dummy laser 102, wherein the dummy laser 102 is configured to provide laser stability via the TEC 58 and modulator control of the modulator 60 while the coherent transmitter 100 is not transmitting in a burst, without providing excess power on an upstream channel 22. The coherent transmitter 100 can further include a variable optical attenuator (VOA) 54 connected to an output of the modulator 60. The VOA 54 can be set to maximum attenuation except for when the coherent transmitter 100 is transmitting in a burst.

The active laser 52 and the dummy laser 102 can be both distributed feedback (DFB) lasers in a silicon photonics (SiP) implementation. The modulator 60 can be a quad-parallel Mach-Zehnder (QPMZ) modulator. The coherent transmitter 100 can further include a coupler 106 configured to combine outputs of both the active laser 52 and the dummy laser 102 for an input to the modulator 60. The coupler 60 can have a A/B split with the A split connected to the active laser 52 and the B split connected to the dummy laser 102, and in an embodiment, A=90 and B=10, although other values are contemplated. The coherent transmitter 100 can be configured to operate in multiple states including an ON state, an OFF state, and a SOFT OFF state, and wherein the ON state is for an assigned burst, the SOFT OFF state is just before the assigned burst to stabilize frequency of the active laser 52 from adiabatic chirp, and the OFF state is for all other times. The active laser 52 and the dummy laser 102 each can have a different frequency. The coherent transmitter 100 can be at an optical network unit (ONU) 14 in a passive optical network (PON) 10 sharing the upstream channel 22 with a plurality of additional ONUs.

In another embodiment, a coherent transmitter 100 configured for TDMA burst transmission includes one or more lasers 52, 102 including either i) a single laser 52 tunable between an active frequency for the TDMA burst transmission and a dummy frequency different from the active frequency, or ii) two lasers 52, 102 including an active laser 52 to output the active frequency and a dummy laser 102 to output the dummy frequency; and a modulator 60 configured to receive an output of the one or more lasers 52, 102, wherein at least one of the one or more lasers 52, 102 are always on to provide laser stability. The coherent transmitter 100 can also include a TEC 58 configured to operate with the one or more lasers 52, 102.

### PON Network

In another embodiment, a passive optical network (PON) 10 includes an optical line terminal (OLT) 12; and a plurality of optical network units (ONU) 14 configured to optical connect to the OLT via an optical distribution network (ODU), wherein each of the plurality of ONUs include one or more lasers; a thermoelectric cooler (TEC) configured to operate with the one or more lasers; and a modulator configured to receive a combined output of the one or more lasers, wherein the one or more lasers are always on providing laser stability via the TEC and modulator control of the modulator while the coherent transmitter is not transmitting in a burst, without providing excess power on an upstream channel due to the one or more lasers either i) being a single laser tuned off of a frequency of interest on the upstream channel when not transmitting in the burst or ii) being two lasers including an active laser and a dummy laser.

In a further embodiment, a PON 10 includes an optical line terminal (OLT) 12; and a plurality of optical network units (ONUs) 14 configured to optically connect to the OLT via an optical distribution network (ODU), wherein each of the plurality of ONUs 14 include one or more lasers; and a modulator configured to receive an output of the one or more lasers, wherein the output of the one or more lasers has a dummy frequency while an ONU is not assigned to transmit data to the OLT and has an active frequency while the ONU is assigned to transmit data to the OLT.

### Coherent TWDM-N PON

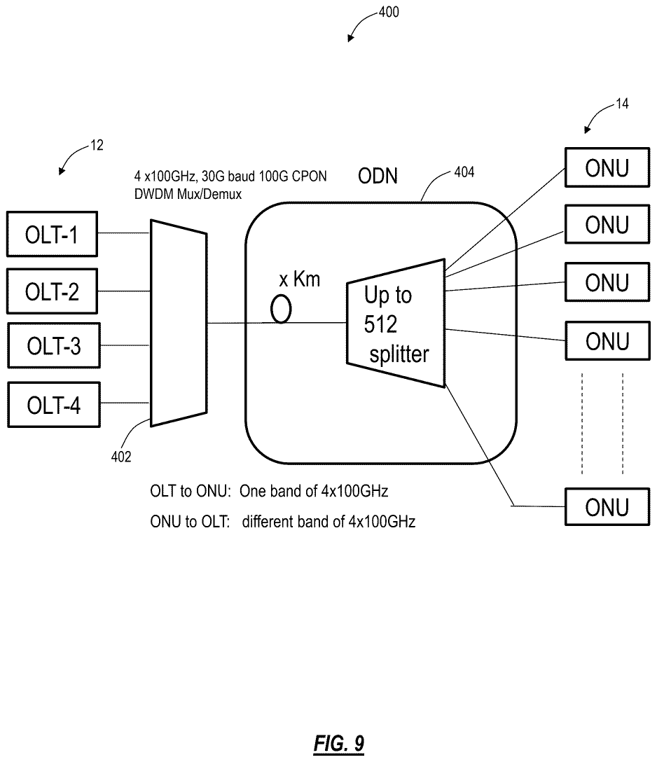

FIG. 9 illustrates a network diagram of a coherent TDMA wavelength division multiplexed (WDM) (TWDM) PON network 400. With the use of coherent transmitters described herein, including the tunability of frequencies, it is possible to support a combination of TDMA and WDM in the PON network 400. The PON network 400 is described for illustrative purposes with four wavelengths, e.g., using a 4×100 multiplexer/demultiplexer 402 to connect four OLTs 12 to an ODN 404 which connects to any number of ONUs 14. Any ONU 14 can tune to any one of the four CPON wavelengths with coherent detection, a low-cost laser 52 can tune over 4×100 GHz, providing a small extra cost for this limited tuning. Of course, four wavelengths is merely an example and other approaches are contemplated. For the PON network 400, it is possible to do different load balance for each of the wavelengths by assigning different number of ONUs for each OLT 12, etc.

Note, the ODN 404 can be a single fiber from the OLTs 12 to the ONUs 14 with a different band of 4×100GH for the upstream channel 22 and the downstream channel 20. Also, this can be added to existing 10G or the like PON systems, using different wavelengths, supporting a brownfield upgrade.

The PON network 400 can be implemented with either the coherent transmitters 100, 200 described herein.

### CONCLUSION

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner-whether collectively, in subsets, or individually-thereby broadening the range of potential embodiments.

What is claimed is:

1. A method of operating a coherent transmitter in a time division multiple access (TDMA) system, the method comprising steps of:
operating in an OFF state while the coherent transmitter is not assigned to transmit data in the TDMA system, wherein operating in the OFF state comprises generating a dummy laser output having a dummy frequency different from an active frequency used to transmit data in the TDMA system; and
operating in an ON state while the coherent transmitter is assigned to transmit data in the TDMA system, wherein operating in the ON state comprises generating an active laser output having the active frequency and modulating the active laser output using a modulator.

2. The method of claim 1, wherein:
operating in the OFF state comprises generating the dummy laser output using a dummy laser; and
operating in the ON state comprises generating the active laser output using an active laser.

3. The method of claim 2, wherein the steps further include controlling temperatures of the dummy laser and the active laser using a thermoelectric cooler (TEC).

4. The method of claim 2, wherein the steps further include
combining outputs of the active laser and the dummy laser for an input to the modulator, via a coupler.

5. The method of claim 4, wherein the coupler has an A/B split with the A split connected to the active laser and the B split connected to the dummy laser, wherein the A split is greater than the B split.

6. The method of claim 1, wherein:
operating in the OFF state comprises setting a laser to the dummy frequency to generate the dummy laser output; and
operating in the ON state comprises setting the laser to the active frequency to generate the active laser output.

7. The method of claim 1, wherein the steps further include,
prior to transitioning from the OFF state to the ON state, transitioning to a SOFT OFF state to stabilize the active laser output.

8. The method of claim 7, wherein the transitioning to the SOFT OFF state occurs <5 μs prior to transitioning to the ON state.

9. The method of claim 7, wherein the transitioning to the SOFT OFF state comprises turning off a dummy laser generating the dummy laser output and turning on an active laser producing the active laser output.

10. The method of claim 7, wherein the transitioning to the SOFT OFF state comprises switching an output of a laser from the dummy frequency to the active frequency.

11. The method of claim 10, wherein the switching the output of the laser is performed using carrier injection or an electro-optic effect.

12. The method of claim 1, wherein the operating in the OFF state comprises controlling the modulator using the dummy laser output.

13. The method of claim 1, wherein the steps further include operating a variable optical attenuator (VOA) connected to an output of the modulator.

14. The method of claim 13, wherein the operating includes setting the VOA to maximum attenuation except for when the coherent transmitter is in the ON state.

15. The method of claim 1, wherein the modulator is a quad-parallel Mach-Zehnder (QPMZ) modulator.

16. The method of claim 1, wherein a coherent receiver in the TDMA system is locked to the active frequency and the dummy frequency is rejected by the coherent receiver.

17. The method of claim 16, wherein the coherent transmitter is at an optical network unit (ONU) in a passive optical network (PON) sharing an upstream channel with a plurality of additional ONUs, and the coherent receiver is at an optical line terminal (OLT) in the PON.

18. A coherent transmitter configured for time division multiple access (TDMA) burst transmission, the coherent transmitter comprising:
one or more lasers comprising either i) a single laser tunable between an active frequency for the TDMA burst transmission and a dummy frequency different from the active frequency, or ii) two lasers including an active laser to output the active frequency and a dummy laser to output the dummy frequency; and
a modulator configured to receive an output of the one or more lasers,
wherein at least one of the one or more lasers are always on to provide laser stability.

19. The coherent transmitter of claim 11, further comprising thermoelectric cooler (TEC) configured to operate with the one or more lasers.

20. A passive optical network (PON) comprising:
an optical line terminal (OLT); and
a plurality of optical network units (ONUs) configured to optically connect to the OLT via an optical distribution network (ODU),
wherein each of the plurality of ONUs include
one or more lasers; and
a modulator configured to receive an output of the one or more lasers, wherein the output of the one or more lasers has a dummy frequency while an ONU is not assigned to transmit data to the OLT and has an active frequency while the ONU is assigned to transmit data to the OLT.
